(19) United States
(12) Patent Application Publication
(10) Pub. No.: US 2007/0299845 A1
(43) Pub. Date: Dec. 27, 2007

(54) LICENSE MANAGEMENT SYSTEM, LICENSE MANAGEMENT SERVER APPARATUS, INFORMATION PROCESSING APPARATUS UTILIZING A LICENSE, AND CONTROL METHOD THEREOF

(75) Inventor: Momoe Tokunaga, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/747,601

(22) Filed: May 11, 2007

(30) Foreign Application Priority Data
Jun. 23, 2006 (JP) 2006-174136

(51) Int. Cl. G06F 21/22; G06F 17/30

(52) U.S. Cl. 707/9; 707/E17.01

(57) ABSTRACT

A floating license management system is applied to a case where a license issuance is requested when all issuable licenses are issued. By issuing an excess license, more users can execute an application software or a program even when a specified number of floating licenses are all being used. A usage history of a license is used as a criterion for determining the issuance of an excessive license.

### BACKGROUND OF THE INVENTION

1. Field of the Invention

The present invention relates to a license management system for executing an application software or a program. In particular, the present invention relates to a license management apparatus which issues a license, an information processing apparatus and an image processing apparatus that utilizes the license, and control method thereof.

2. Description of the Related Art

A floating license management system manages a license for executing an application software or a program as a floating license in a management server on a specific local area network (LAN) such as an in-house LAN. The floating license management system manages assigning and returning of a license and enables use of a specified number of licenses on the LAN. When such a system receives a request to issue a license from client computers exceeding the number of licenses which can be managed by the management server, the system cannot issue new licenses. In this case, the system notifies the client requesting a new license that there is an upper limit to the number of license, and the client is not able to execute an application or a program.

To overcome the above problem, a license management program initializes the license on another server when there is no issuable license at the time of request. Consequently, the license management system obtains a distributable license and issues the license (for example, refer to Japanese Application Laid-Open No. 2004-126996).

Further, a license management center can manage a usage status of an application or a program in each client (i.e., the number of license). Furthermore, a license fee can be received when an application or a program exceeding the number of licenses is being executed (for example, refer to Japanese Application Laid-Open No. 2000-305775).

Moreover, there is a technique for realizing operating functions such as copying, printing, and sending a facsimile in a multifunctional printer by receiving a license from a license management apparatus (for example, refer to Japanese Application Laid-Open No. 2003-122537).

However, according to the prior art described above, when all of the licenses managed by the management server are being used, a distributable license cannot be obtained. Therefore, further use of licenses is not possible, and the problem remains unsolved.

### SUMMARY OF THE INVENTION

The present invention is directed to a license management system which allows more users to utilize an application software or a program by temporarily assigning an excess license.

The present invention is applied to a floating license management system in which a license issuance is requested when all of the issuable licenses have been assigned. By issuing an excessive license, the floating license management system allows more users to execute an application or a program even when the specified number of floating licenses is all being used. In this system, a usage history of a license is used as a condition for determining the issuance of an excessive license.

According to an aspect of the present invention, a license management system includes a management server configured to manage an issue a specified number of licenses that enable use of an application software in an information processing apparatus and a plurality of information processing apparatuses on which an application software is loaded, and which requests the management server apparatus to issue a license when using an application software and receives a license that enables use of the application software. The license management system includes at least one license storage unit configured to store at least one license being used by the plurality of information processing apparatuses, a history storage unit configured to store a usage history of the application in each of the plurality of information processing apparatuses, a license management unit configured to determine whether a license can be issued when a license issuance request in newly received from an information processing apparatus from among the plurality of information processing apparatuses, a license issue unit configured to issue a license to the information processing apparatus according to a determination result of the license management unit, an excess license determination unit configured to determine whether to issue an excess license according to a usage history of an application software of each information processing apparatus stored in the history storage unit, wherein the license management unit refers to a number of licenses being used which is stored in the at least one license storage unit when a license issuance request is received from the information processing apparatus, wherein where the license management unit determines there are remaining licenses, the license management unit instructs the license issue unit to issue a license, and wherein when the license management unit determines there is no remaining license, the license management unit instructs the license issue unit to issue an excess license according to a determination result of the excess license issue unit.

According to another aspect of the present invention, a management server apparatus is configured to manage and issue a specified number of licenses to enable use of an application software in a plurality of information processing apparatuses. The management server apparatus includes at least one license storage unit configured to store at least one license being used by the plurality of information processing apparatuses, a history storage unit configured to store a usage history of the application software of each of the plurality of information processing apparatuses, a license management unit configured to determine whether a license can be issued in a case where an information processing apparatus from among the plurality of information processing apparatuses requests the management server apparatus to newly issue a license, a license issue unit configured to issue a license to the information processing apparatus according to a determination result of the license management unit, and an excess license determination unit configured to determine whether to issue an excess license according to a usage history of an application software of each information processing apparatus stored in the history storage unit, wherein the license management unit refers to the at least one license being used stored in the at least one license storage unit when a license issuance request is received from the information processing apparatus, wherein when the license management unit determines there are remaining licenses, the license management unit instructs the license issue unit to issue a license, and wherein when the license management unit determines there is no remaining license, the license management unit instructs the license issue unit to issue an excess license according to a determination result of the excess license issue unit.

According to yet another aspect of the present invention, an information processing apparatus is configured to request a management server apparatus to issue a license when using an application software and to receive a license that enables use of the application software. The information processing apparatus includes a history storage unit configured to store a usage history of the application software, a license request unit configured to request the management server apparatus to newly issue a license when the application software is used, an application management unit configured to enable use of the application software based on a license received from the management server apparatus, wherein the application management unit sends a usage history stored in the history unit to the management server apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a floating license management system according to an exemplary embodiment of the present invention.

FIG. 2 illustrates the entire system according to a first exemplary embodiment of the present invention.

FIG. 3 illustrates cumulative usage time stored as a usage history according to a first exemplary embodiment of the present invention.

FIG. 4 illustrates usage frequency stored as a usage history according to a first exemplary embodiment of the present invention.

FIG. 5 illustrates number of license requests stored as a usage history according to a first exemplary embodiment of the present invention.

FIG. 6 is a screen image for selecting a usage history to be obtained according to a first exemplary embodiment of the present invention.

FIG. 7 is a screen image for selecting objects to compared for determining whether to issue an excess license according to a first exemplary embodiment of the present invention.

FIG. 8 is a screen image for selecting a method of determining whether to issue an excess license according to a first exemplary embodiment of the present invention.

FIG. 9 is a screen image for setting number of excess licenses that can be issued according to a first exemplary embodiment of the present invention.

FIG. 10 is a screen image for selecting a storage location of a usage history according to a first exemplary embodiment of the present invention.

FIG. 11 is a flowchart of the entire process according to a first exemplary embodiment of the present invention.

FIG. 12 is a flowchart of an excess license issue determination process according to a first exemplary embodiment of the present invention.

FIG. 13 is a flowchart of an excess license issue determination process according to a first exemplary embodiment of the present invention.

FIG. 14 is a flowchart for checking whether an excess license can be issued according to a first exemplary embodiment of the present invention.

FIG. 15 illustrates weighting of each client according to a second exemplary embodiment of the present invention.

FIG. 16 illustrates the weighted cumulative usage time of each client and the stored result as a usage history according to a second exemplary embodiment of the present invention.

FIG. 17 illustrates the cumulative usage time stored as a usage history for each time period according to a second exemplary embodiment of the present invention.

FIG. 18 illustrates an entire system according to a third exemplary embodiment of the present invention.

### DETAILED DESCRIPTION OF THE EMBODIMENTS

Various exemplary embodiments, features, and aspects of the invention will be described in detail below with reference to the drawings.

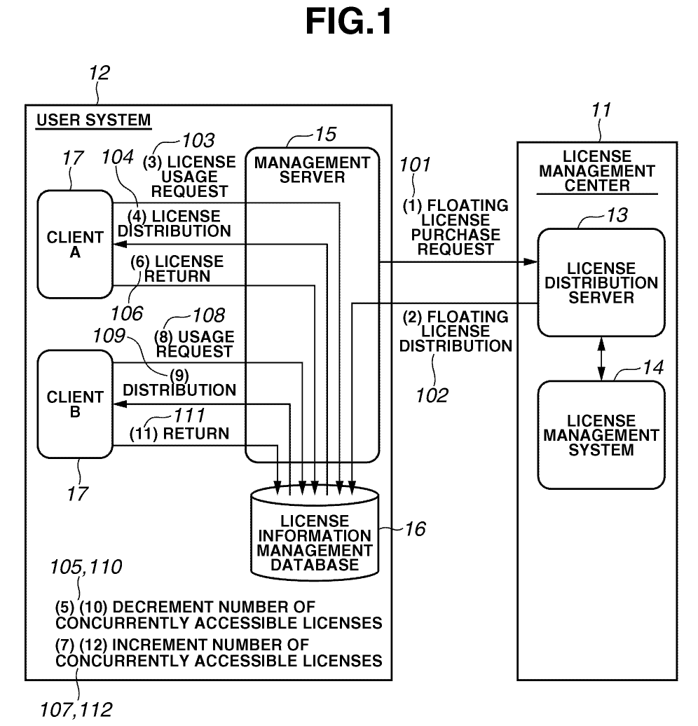

FIG. 1 illustrates the overall configuration of a floating license management system according to a first exemplary embodiment of the present invention.

The floating license management system includes a license management center 11 and a user system 12. The license management center 11 includes a license distribution server 13 and a license management system 14. The user system 12 includes a management server 15, license information management database 16, and a client 17, and is connected through a network.

At the start of handling a floating license, the management server 15 sends a request to the license distribution server 13 to purchase a floating license to be used in the user system 12 (101). The license distribution server 13 receives the request and distributes the floating license to the management server 15 (102). The management server 15 receives the floating license and manages the floating license in the license information management database 16.

When executing an application or a program, client A and client B 17 make a request for using a license to the management server 15 managing the floating license (103, 108). Upon receipt of the request, the management server 15 distributes the license to the clients A and B 17 (104, 109). The license information management database 16 decrements the number of concurrently accessible floating licenses when distributing the license (105, 110). Thus, the license information management database 16 manages the number of distributable floating licenses. Client A and client B 17 return the license to the management server 15 when the clients have finished using an application or a program (106, 111). Then, the license information management database 16 increments the number of concurrently accessible floating licenses (107, 112).

An application management module for managing an application or a program is installed in client A and in client B 17. The application management module manages a license in client A and client B 17. The application management module communicates with the management server 15 to request, receive, and return a license. The application management module controls the use of an application or a program by client A and client B when receiving and returning a license.

The license management center 11 and the user system 12 are connected through the Internet or a wide area network (WAN). The license management center 11 can also issue licenses to a plurality of user management systems.

In the present embodiment, the floating license is managed under the following conditions: first, the number of floating licenses managed by the management server is 20; second, all of the 20 licenses are being used by the client group 17.

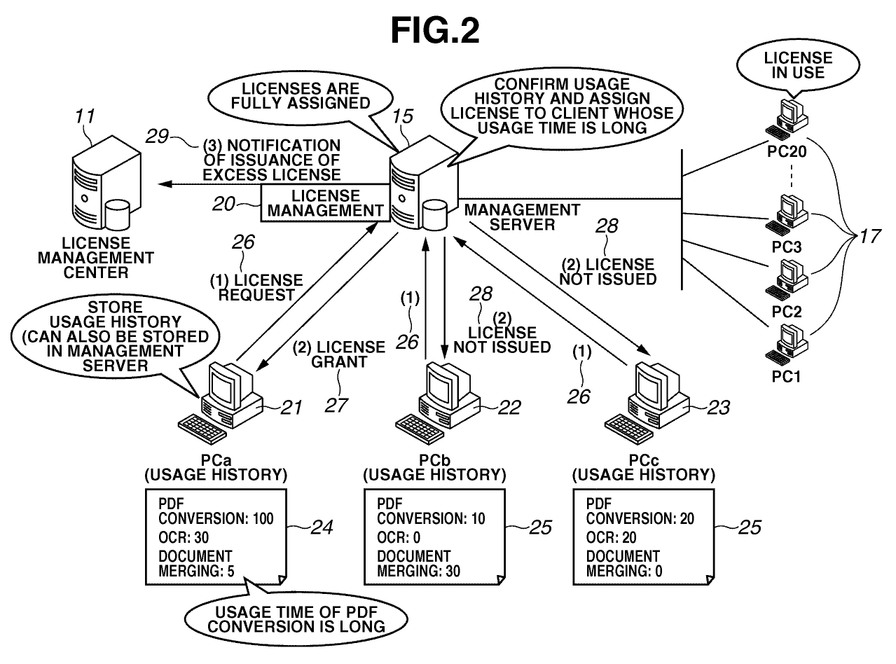

FIG. 2 illustrates an entire system according to the present embodiment of the present invention. The license management center 11, management server 15, and clients 17, 21 to 23 are connected through a network. As indicated by the license conditions, all of the 20 licenses managed by a license management module 20 of the management server 15 are being used by the client group 17.

In the present embodiment, a usage history is stored when a floating license is utilized. In the case where all of the licenses managed by the management server 15 are assigned, it is determined whether an excess license should be assigned based on the usage history. FIG. 2 illustrates an example of a cumulative usage time of each function of an application or a program stored as a usage history.

Under the conditions described above, when clients 21 to 23, or personal computers PCa 21, PCb 22, and PCc 23 each request a license, the management server 15 checks the usage histories of the clients requesting a license. If a request is made by a client who meets a certain condition, the management server 15 temporarily assigns an excess license to the client. However, the management server 15 does not respond to a license request from a client who does not meet a certain condition (28).

In the example of FIG. 2, the management server 15 checks the usage history 24 of the client PCa 21. The cumulative time in which the client PCa 21 has used a portable document file (PDF) conversion function is longer as compared to that in the usage history 25 of the client PCb 22 and PCc 23. Therefore, only PCa 21 is granted a license (27), and licenses are not issued to clients PCb 22 and PCc 23 (28). After issuing an excess license, the management server 15 notifies, as needed, the license management center 11 of the issuance.

In the above example, the PDF conversion, optical character recognition (OCR), and document merging are separate applications. However, these applications can also be supplied as separate functions of an application. All of the applications or functions, i.e., PDF conversion, OCR, and document merging, can be used by a client when a license is granted. However, a license can be issued for each of the PDF conversion, OCR, and document merging application or function. In such a case, the 20 licenses as described above can be a license granting use of all applications. Alternatively, the number of licenses can be decided for each application.

In the example described above, since the usage time of one application is long in the usage history 24 of client PCa 21, an excess license is issued to PCa 21. Consequently, the PCa 21 is able to use all applications or functions. However, if a license is to be issued separately for each application, the license issuance can be determined based on the usage history of each application. That is, the excess license issued to client PCa 21 can be limited only to a license for using the PDF conversion application of which the usage time is long in the usage history 24.

An application management module for managing an application or a program is installed in the clients 17, 21 to 23. The application management module manages licenses in clients 17, 21 to 23 and communicates with the management server 15 to request, receive, and return a license. In addition, the application management module controls the use of an application or a program by the clients 17, 21, to 23 when the license is received and returned.

The license management center 11 can be placed on the same LAN as the management server 15 and each of the clients 17, 21, to 23. However, the license management center 11 is generally located outside the LAN and is connected through the Internet or a WAN.

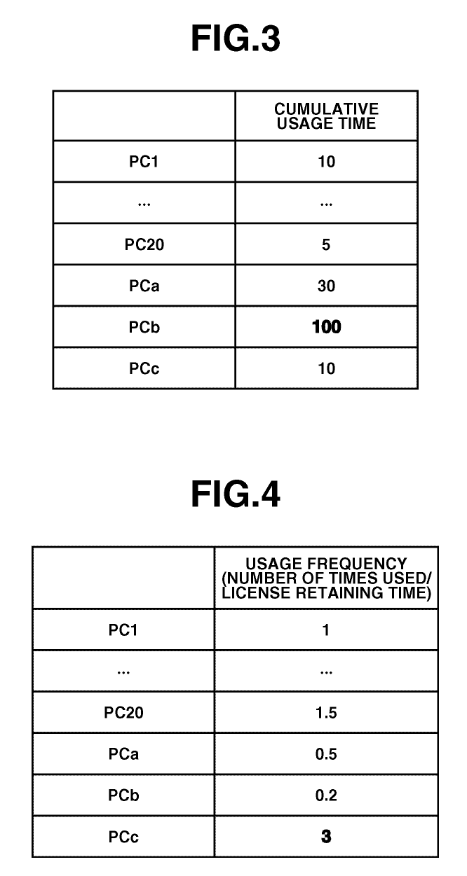

In the present embodiment, various usage histories can be obtained in accordance with the objective of assigning an excess license. The present embodiment is described based on examples of typical histories as illustrated in table 1 below and in FIG. 3 to FIG. 5. A combination of these histories can also be used as a usage history.

TABLE 1

| | Usage History | Condition For Assigning |
|---|---|---|
| FIG. No. | To Be Obtained | Excess License (example) |
| 3 | cumulative usage time | client with longest usage time |
| 4 | usage frequency | client with highest usage |
| | | frequency |
| 5 | number of license | client requesting many |
| | requests | licenses, regardless |
| | | of its usage |

FIG. 3 illustrates an example in which cumulative usage time is selected as a usage history.

A cumulative usage time of an application during the period in which a client PC retains a license is stored so that an excess license can be issued to a client having the longest cumulative usage time. In FIG. 3, the cumulative usage time of client PCb 22 is longer as compared to clients PCa 21 and PCc 23. Therefore, when clients PCa 21, PCb 22, and PCc 23 request issuance of a license under the above conditions, an excess license is issued to client PCb 22. The cumulative usage time can be indicated in any unit of time such as days, hours, minutes, or seconds.

FIG. 4 illustrates an example in which usage frequency is selected as a usage history to be stored.

A usage frequency (number of times used/license retaining time) of an application or a program during the period in which a client PC retains a license is stored so that an excess license can be issued to a client having a highest usage frequency. In FIG. 4, the usage frequency of client PCc 23 is higher as compared to clients PCa 21 and PCb 22. Therefore, when clients PCa 21, PCb 22, and PCc 23 request issuance of a license under the above conditions, an excess license is issued to client PCc 23.

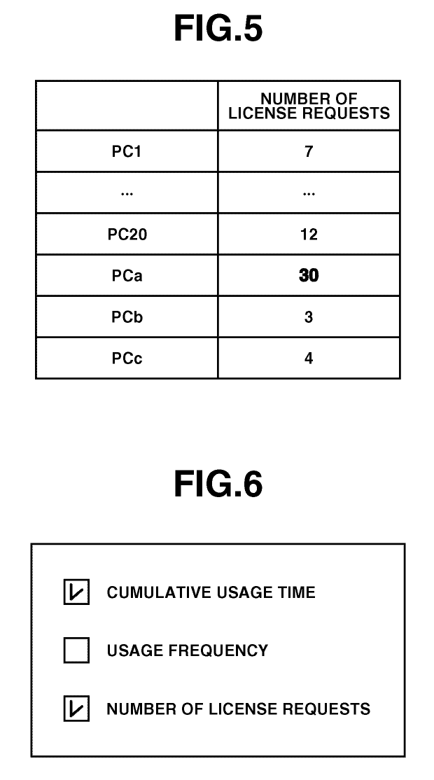

FIG. 5 illustrates an example in which a number of license requests are selected as a usage history to be stored. A number of license requests are stored as a usage history regardless of whether a license is issued after requesting a license so that an excess license can be issued to a client having the largest number of license requests. In FIG. 5, the number of license requests of client PCa 21 is larger as compared to clients PCb 22 and PCc 23. Therefore, when clients PCa 21, PCb 22, and PCc 23 request the issuance of a license under the above conditions, an excess license is issued to client PCca 21.

FIG. 6 is a selection screen for selecting a usage history which is to be obtained. In this example, the cumulative usage time and the number of license requests are stored as usage histories.

FIG. 3 to FIG. 5 describe methods of determining clients to which a license is issued. In these examples, an excess license is issued only to the client having the longest cumulative usage time or highest usage frequency among the clients requesting an excess license. However, the present embodiment is not limited to the above determination methods. The license issuance can also be determined by combining the objects of comparison in Table 2 and the determining methods in Table 3 described below.

TABLE 2

| No. | Objects Of Comparison |
|---|---|
| 1 | Histories of all clients requesting an excess license |
| | PCa 21, PCb 22, and PCc 23 in FIG. 2 |
| 2 | Histories of all clients using a license and all clients |
| | requesting an excess license |
| | PC1 to 20 (17), PCa 21, PCb 22, and PCc 23 in FIG. 2 |
| 3 | Average value of histories of all clients using a license, |
| | and histories of all clients requesting an excess license |

TABLE 3
Determining Method

| No. | Determining Method |
|---|---|
| 1 | Clients among objects of comparison whose values of usage |
| | histories are high |
| 2 | Clients among objects of comparison whose values of usage |
| | histories are low |
| 3 | Clients among objects of comparison whose values of usage |
| | histories are above a certain threshold |
| 4 | Clients among objects of comparison whose values of usage |
| | histories are below a certain threshold |

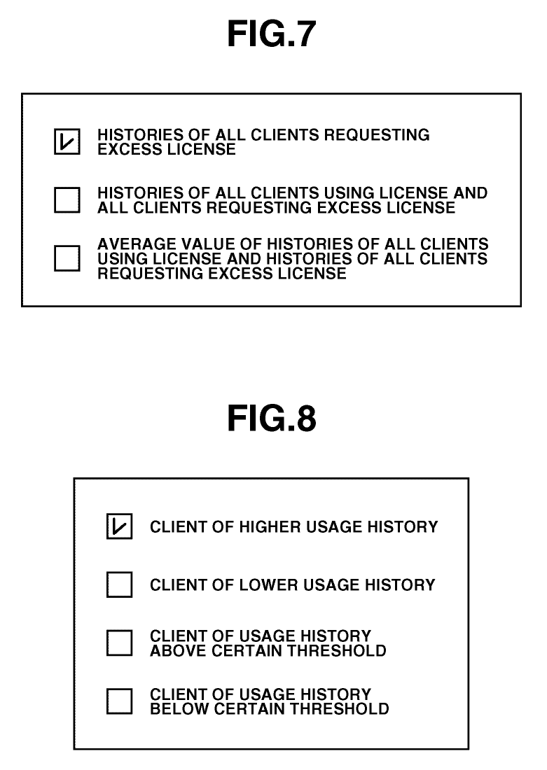

FIG. 7 illustrates a selection screen for selecting objects of comparison to determine whether an excess license can be issued. In the example of FIG. 7, histories of all clients requesting an excess license are set as objects of comparison. Therefore, the usage histories of clients PCa 21, Pcb 22, and PCc 23 in FIG. 2 are compared.

FIG. 8 illustrates a selection screen for selecting a method of determining an issuance of an excess license. In the example of FIG. 8, the excess license is issued to the client whose value of a usage history is highest among the selected objects of comparison.

The number of excess licenses that can be issued is not limited to one. However, an upper limit can be set as to the total number of issuable excess licenses.

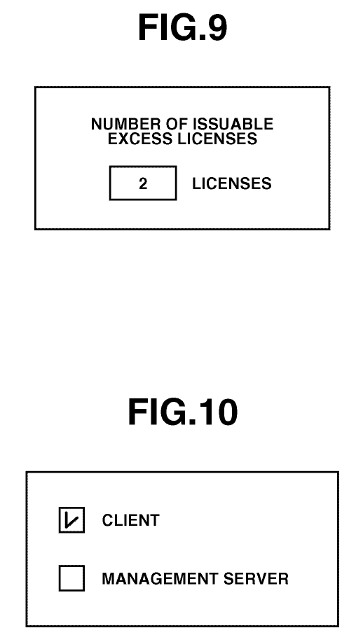

FIG. 9 illustrates a screen for setting the number of excess licenses that can be issued. In the example of FIG. 9, up to 2 licenses can be issued. Additionally, in order to prevent unauthorized use of licenses, control can be performed to set an upper limit to the total number of excess licenses that can be issued.

The management server 15 makes settings for selecting usage histories as illustrated in FIG. 6, selecting objects of comparison to determine whether a license can be issued in FIG. 7, and selecting a method of determining an issuance of an excess license in FIG. 8, and the number of excess licenses as shown in FIG. 9. The settings can also be made by the license management center 11.

In the present embodiment, there are two storage locations for storing the usage histories of clients as described below.

1. Clients 17, 21 to 23

The usage history is stored in each of the clients 17 that use a license. When a license is assigned, the usage history of a client 17 which will use the license is obtained and temporarily stored in the management server 15. In the case where a client requests an excess license, the usage histories of clients 21 to 23 that requested an excess license and the usage history of the client that is temporarily stored in the management server 15 are compared so that an excess license issuance is determined.

2. Management Server 15

The usage histories of all clients 17, 21 to 23 that can use a license are managed by the management server 15.

FIG. 10 illustrates a selection screen for selecting the storage location of the usage histories. In the example of FIG. 10, the usage histories are stored in each client. The setting of FIG. 10 is made on the management server 15. The setting can also be made on the license management center 11.

In the present embodiment, the management server 15 notifies the license management center 11 of the issuance of an excess license. Accordingly, the issuance history of an excess license can be managed by the license management center 11, and the following processing can be performed depending on purposes:

1. Additional Charging of the Excess License Fee

The usage of an excess license is checked on a regular basis and an additional license fee is charged for the used excess license. The process can be utilized to restrict unlimited use of an excess license.

2. Temporarily Decreasing the Number of Licenses

The number of licenses is temporarily decreased for the period of time in which an excess license is used. For example, when one excess license is issued for 2 hours while 20 floating licenses are granted, the floating license is decreased to 19 licenses for 2 hours in a different time period. The period of time in which the number of licenses is decreased can be set in a time period when the usage frequency is low by referring to the usage history. The process can be used in the case where the number of usable licenses is to be kept overall constant.

3. Calculating the Usage of an Issued Excess License

The usage of an excess license is calculated from the issuance history of an excess license. The process can be applied, for example, when a form of license or number of licenses that is most appropriate to the operation of a client, is to be presented at the time of renewing a license contract.

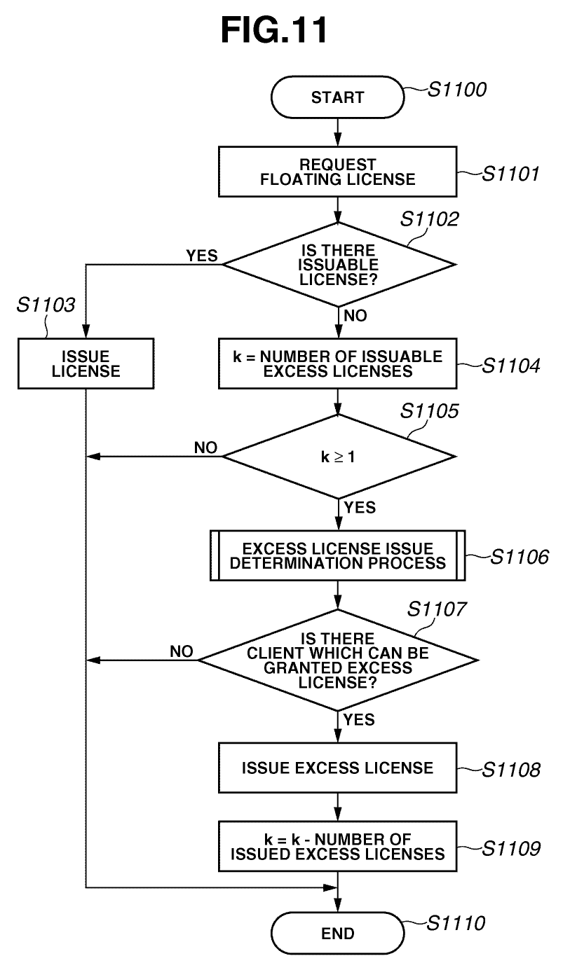

FIG. 11 is a flowchart of the entire process of the present embodiment. The process begins in step S1100 and a floating license request is made by a client in step S1101. When the client requests a license, the floating license management system in the present embodiment checks, in step S1102, whether there are licenses that can be issued. In the case where there is an issuable license (YES in step S1102), the floating license management system issues a license as usual in step S1103. The process then ends in step S1110.

When an issuable license is not available (NO in step S1102), in step S1104, the floating license management system obtains k, or the number of issuable excess licenses set previously. Then, a determination is made in step S105 if “k” is greater than or equal to one. If “k” is 0 (NO in step S1105), then the floating license management system does not issue an excess license and process ends in step S1110.

When the number of issuable excess licenses is greater than or equal to one (YES in step S1105), in step S1106, an excess license issue determination process determines the client which can be granted an excess license.

In step S1107, a determination is made whether there is a client that can be granted an excess license. If it is determined that there is a client that can be granted an excess license, flow proceeds to step S1108, where the floating license management system issues an excess license to the client. After issuing an excess license, in step S1109, the floating license management system decrements the number of issuable excess license, i.e., “k” by the number of issued excess licenses. The process then ends in step S1100.

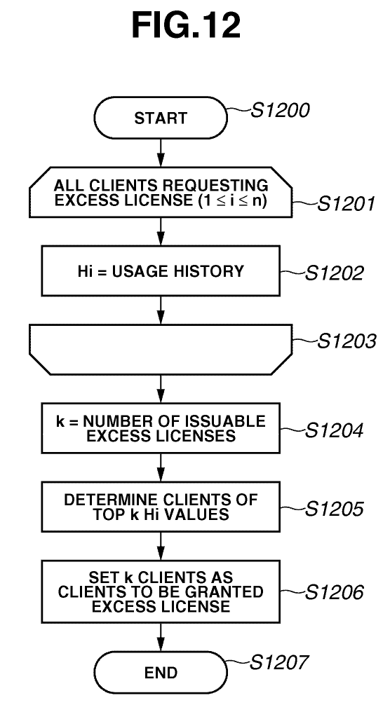

FIG. 12 is a flowchart of the excess license issue determination process of step S1106, which is performed by the management server 15. FIG. 12 illustrates an example where the objects of comparison are the usage histories of all clients requesting an excess license, wherein the determination condition is a client whose value of a usage history is high.

The process begins in step S1200, and in step S1201, the number of clients requesting an excess license is obtained. In step S1201, “i”, is a client requesting an excess license and “n” is the number of all clients requesting an excess license. Next, in step S1202, the management server 15 obtains a usage history Hi for all clients requesting an excess license that are the objects of comparison.

After obtaining the usage histories of all clients requesting an excess license (step S1203), in step S1204, the management server 15 obtains k, or the number of issuable excess licenses. Next, in step S1205, the management server 15 then calculates the values of the top “k” from values of the usage history Hi of each client obtained in the process of step S1202. In step S1206, the management server 15 sets the clients having the values calculated in the process of step S1205 as the clients to be granted an excess license. The process then ends in step S1207.

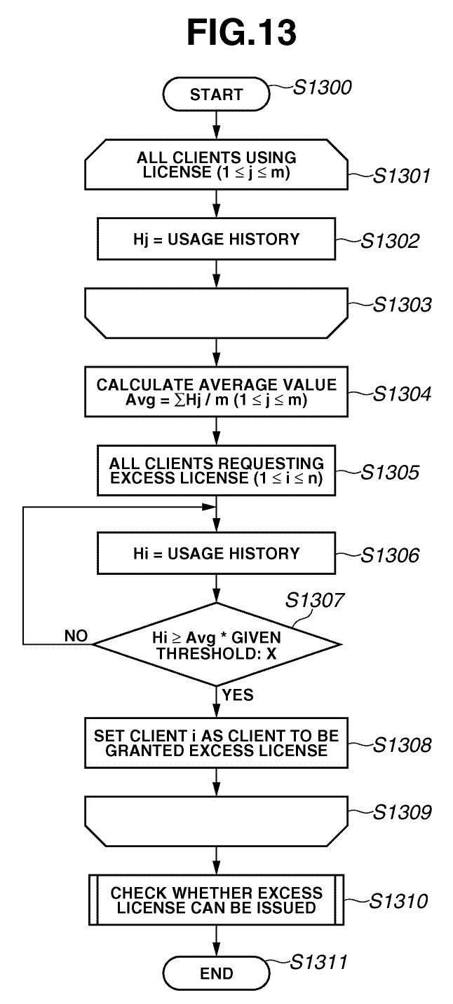

FIG. 13 is a flowchart of another example of the excess license issue determination process of step S1106, wherein the excess license issue determination process is performed by the management server 15. In FIG. 13, the object of comparison is the average value of the usage history of a client using a license, and the determination condition is that the value of a usage history is above a given threshold.

The process begins in step 1300, and in step S1301, the number of clients using a license is obtained. In step S1301, “j” represents a client using a license while “m” represents the number of all clients. Next, in step S1302, the management server 15 obtains a usage history Hj of all clients using a license.

After obtaining the usage histories of all clients (step S1303), in step S1304, the management server 15 calculates the average value Avg of the obtained usage histories Hj. Next, in step S1305, all the clients requesting an excess license is obtained. In step S1305, “i” represents a client requesting an excess license, while “n” represents the number of all clients requesting an excess license. Then, in step S1306, the management server 15 obtains a usage history Hi (step S1306) of all clients requesting an excess license.

In step S1307, the management server 15 compares the obtained usage history Hi of each client and the average value Avg calculated in step S1304. If the usage history Hi of a client is greater than the average value*given threshold X (YES in step S1307), then in step S1308, the client is set as a client to be granted an excess license. In the case where the condition of the process in step S1307 is not met (NO in step S1307), flow returns to step S1306, where the management server 15 shifts the process to the next client.

After the process is performed for all clients requesting an excess license (step S1309), in step S1310, the management server 15 checks whether a license can be issued to all clients set as clients to be granted an excess license. The process then ends in step S1311.

In this example, “m” is the number of all clients using a license and “n” is the number of all clients requesting an excess license. Therefore, “m+n” is the total number of clients. In the example of FIG. 2, “m” corresponds to the number of clients PC1 to PC20 (17), or 20. Similarly, “n” is the number of client PCa 21, PCb 22, and PCc 23, or 3.

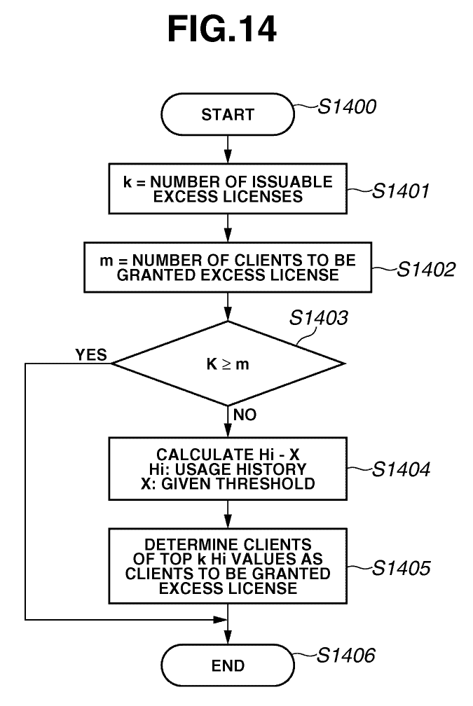

FIG. 14 is a flowchart of the process for checking whether an excess license can be issued of step S1310. The process is performed on the management server 15.

When a determination condition of an excess license is set above a given threshold, a plurality of clients meeting the condition may be set as clients to be granted an excess license, as described in FIG. 13. However, since the number of excess licenses that can be issued is predetermined (refer to FIG. 9), an excess license cannot be issued if the number of clients to be granted an excess license exceeds the predetermined number of licenses. The flow illustrated in FIG. 14 controls the number of clients to be granted an excess license to be equal to or less than the number of issuable excess licenses.

The process begins in step 1400, and in step S1401, the management server 15 obtains “k”, or the number of issuable excess licenses, which is previously set. Next, in step S1402, the management server 15 obtains “m”, or the number of clients that are to be granted an excess license which is determined by the flow of FIG. 13.

In step S1403, the management server 15 compares “k”, the number of issuable excess licenses and “m”, the number of clients to be granted an excess license. In the case where “m” is less than “k” (YES in step S1403), flow proceeds to step S1406, where the process ends.

If “m” is greater than or equal to “k” (No in step S1403), the process proceeds to step S1404, where the management server 15 calculates the difference between a given threshold X and the usage history Hi of each of the “m” clients to be granted an excess licenses which is obtained in step S1306 in FIG. 13. As a result of the calculation, in step S1405, the management server 15 sets the “k” clients having the top values of a usage history as the clients to be granted an excess license. The process then ends in step S1406.

The first exemplary embodiment describes a usage time, or number of times of usage as an obtained usage history. The second exemplary embodiment of the present invention describes a method of obtaining other usage histories. Examples of such usage histories are illustrated in table 4 below. In the present exemplary embodiment, for ease of description, the objects of excess license issue determination will be all clients requesting an excess license, and the determination method will be based on top clients whose values of a usage history are the highest. However, the present invention is not limited to these objects for excess license issue determination and this determination method, and any object for excess license issue determination and any determination method that would enable practice of the present invention are applicable.

TABLE 4
Contents Of Usage History

| FIG. | Usage History To Be | Condition for Assigning |
|---|---|---|
| No. | Obtained | Excess License (example) |
| 15 | Weighted usage history | Client having authority (such as |
| 16 | of each client | administrator), regardless of |
| | | usage time or usage frequency |
| 17 | Usage history in | Client satisfying condition for |
| | each time period | obtaining license in a time |
| | | period of requested license |

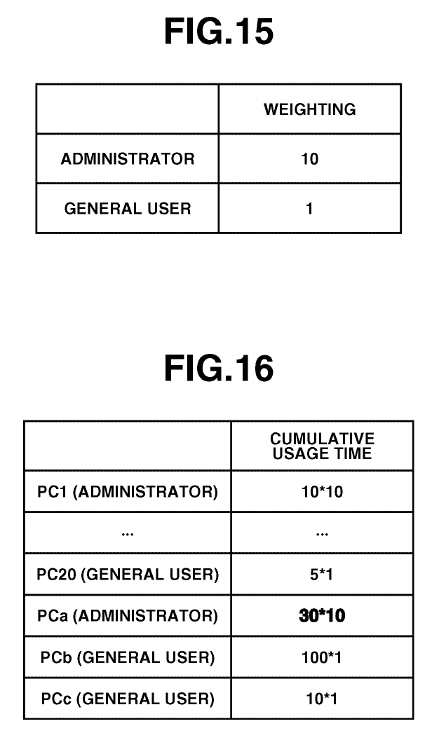

FIGS. 15 and 16 illustrate an example in which weighted values described in the first embodiment are selected for each user as usage histories to be stored. FIG. 15 illustrates an example of the weighting values. In FIG. 15, the weighting value is 10 for an administrator and one for a general user.

FIG. 16 illustrates an example in which the cumulative usage time described as a usage history in FIG. 3 in the first embodiment is weighted by the weighting values illustrated in FIG. 15. Each client has an attribute of either an administrator or a general user, and the usage history is weighted according to the attribute. In the example of FIG. 3, the cumulative usage time of client PCb 22 is longer than client PCa 21. However, since client PCa 21 is an administrator, client PCa 21 is weighted and is granted an excess license.

In the examples of FIGS. 15 and 16, weighting is performed by multiplication. However, the present invention is not limited to this method, and any method that would enable practice of the present invention is applicable.

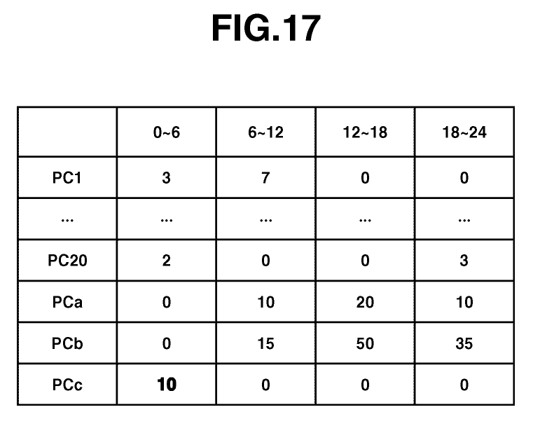

FIG. 17 illustrates an example in which a usage history is stored for each time period. When a client requests an excess license, the management server 15 compares the usage histories of the time period in which a request is made. Then, a license is issued which is limited to the use during the time period in which the license will be most possibly used. In this example, time is described on a 24-hour basis.

In FIG. 17, the cumulative usage time described in FIG. 3 in the first embodiment is stored for a time period of 6 hours. If clients PCa 21, PCb 22, and PCc 23 request an excess license at 4:00, the license is issued to client PCc 23 whose cumulative usage time is longest during a period from 0:00 to 6:00. Moreover, since the cumulative usage time of client PCc 23 after 6:00 is short, an excess license limited to use of 2 hours (i.e. from 4:00 to 6:00) can be issued. The time period for storing a usage history is not limited to the 6 hours, but can be set freely.

In the first and second exemplary embodiments, an application or a program is executed on an information processing apparatus or a personal computer. The third exemplary embodiment describes a case where an application or a program is executed on an image processing apparatus.

An image processing apparatus according to the third exemplary embodiment includes a multifunction peripheral (MFP) which scans, copies, and prints document data or an original, sends e-mail, and performs a file transfer. Additionally, a Java® platform for executing an application or a program is installed in the image processing apparatus according to the present embodiment. Examples of an application or a program which runs on such an image processing apparatus including the Java® platform are document data management, PDF conversion, and OCR conversion. The licenses necessary for executing such applications and programs on the image processing apparatus are managed in the present embodiment.

In the present embodiment, for ease of description, the objects of an excess license issue determination are all clients requesting a license, and the determination method will be carried out based on top clients whose value of usage history is high. However, any object of an excess license issue determination and any determination method that would enable practice of the present invention are applicable.

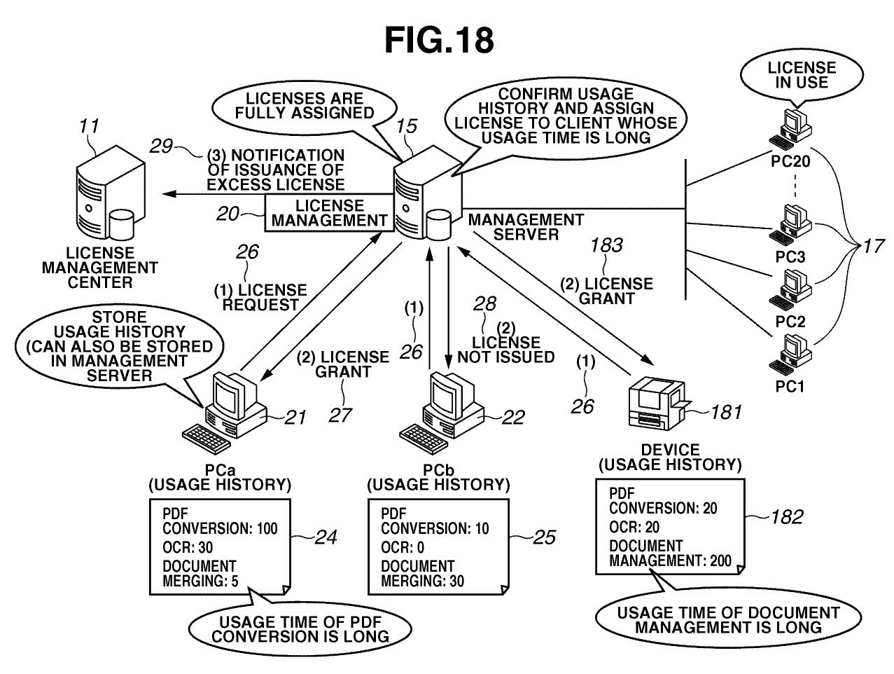

FIG. 18 illustrates an entire system configuration of the present embodiment. In FIG. 18, the elements other than the image processing apparatus 181 are allocated the same reference numerals as in FIG. 2, and further description about these elements are not repeated herein. A license management center 11, management server 15, clients 17, 21, 22, and an image processing apparatus 181 are connected through a network. All of the 20 licenses managed by the management server 15 are used by client 17 as described in the above condition. PCa 21 and PCb 22 are information processing apparatuses. The cumulative usage time of each function of an application or a program is stored as a usage history.

In FIG. 18, each of the clients PCa 21 and PCb 22 and the image processing apparatus 181 requests a license under the above condition (26). The management server 15 checks the usage history of each client. The management server 15 temporarily assigns an excess license to a client satisfying a certain condition and does not respond to a client which does not satisfy the condition (28). With respect to the usage history 24 of PCa 21, the cumulative usage time of a PDF conversion function is long. In addition, with respect to the usage history 182 of the image processing apparatus 181, the cumulative usage time of a document management function is long. Therefore, PCa 21 and the image processing apparatus 181 are granted a license respectively (27, 183). After issuing an excess license, the management server 15 notifies, as necessary, the license management center of the issuance (29) of the excess license.

In the above exemplary embodiments, usage time, usage frequency, and number of license requests are used as usage histories serving as a basis for issuing an excess license. However, other criterion or methods which determine a particular usage of a specific user, client, or an image processing apparatus, can also be used.

The present invention can be embodied as, for example, a system, an apparatus, a method, a program, or a storage medium. Further, the present invention can be applied to a system including a plurality of devices or to an apparatus of a single device.

The object of the present invention can also be achieved by directly or remotely supplying to a system or an apparatus a program code of the software which realizes the functions of the above exemplary embodiments, so that a computer (or CPU or MPU) of the system or the apparatus can retrieve and execute the program code. In this case, the program to be supplied corresponds to the flowchart described in the exemplary embodiments.

In the above case, the software (program code) itself constitutes the present invention. Such programs can take any form, for example, object code, a program executed by an interpreter, or script data supplied to an OS. The storage medium which stores the software can be, for example, a floppy disk, hard disk, optical disk, magnetic optical disk (MO), CD-ROM, magnetic tape, nonvolatile memory card, ROM, or digital versatile disk (e.g., DVD-ROM, DVD-R).

Such programs can also be supplied by the system or the apparatus accessing a web page on the Internet through the browser of a client computer. The program itself or a compressed file including an auto-install function can be downloaded from the web page onto a hard disk. In addition, the program code can be broken up into a plurality of files, and each file can be downloaded from different web pages. Namely, the present invention can be applied to WWW or ftp servers that allow numerous users to download the program files so that the functions or processes of the present invention can be realized on their computers.

Furthermore, such program code can be encrypted and stored in a storage medium such as a CD-ROM to be distributed to users. A user who meets the determining conditions can download the key information for decrypting the program from a web page through the Internet. By using the key information, the encrypted program can be executed and installed in a computer to realize the functions of the present invention.

Furthermore, based on an instruction of the program, the operating system (OS) or other application software running on the computer can execute part or all of the processing so that the functions of the above-described embodiments can be realized.

Furthermore, the supplied program code can be stored in a memory equipped in a function enhancement board of the computer or a function enhancement unit connected to the computer, and a CPU in the function enhancement board or the function enhancement unit can execute all or part of the processing based on the instructions of the program code to realize the operations of the embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-174136 filed Jun. 23, 2006, which is hereby incorporated by reference herein in its entirety.

What is claimed is:

1. A license management system including a management server configured to manage and issue a specified number of licenses that enable use of an application software in an information processing apparatus, and a plurality of information processing apparatuses on which the application software is loaded and which request the management server apparatus to issue a license when using an application software and receive a license that enables use of the application software, the license management system comprising:
at least one licenses storage unit configured to store a at least one license being used by the plurality of information processing apparatuses;
a history storage unit configured to store a usage history of the application software of each of the plurality of information processing apparatuses;
a license management unit configured to determine whether a license can be issued in a case where an information processing apparatus from among the plurality of information processing apparatuses requests the management server apparatus to issue a new license;
a license issue unit configured to issue a license to the information processing apparatus according to a determination result of the license management unit; and
an excess license determination unit configured to determine whether to issue an excess license according to a usage history of an application software of each information processing apparatus stored in the history storage unit,
wherein the license management unit refers to the at least one license being used stored in the at least one license storage unit when a license issuance request is received from the information processing apparatus;
wherein the license management unit instructs the license issue unit to issue a license in a case where the license management unit determines there are remaining licenses; and
wherein the license management unit instructs the license issue unit to issue an excess license according to a determination result of the excess license issue unit in a case where the license management unit determines there is no remaining license.

2. A management server apparatus configured to manage and issue a specified number of licenses that enable use of an application software in a plurality of information processing apparatuses, the management server apparatus comprising:
at least one licenses storage unit configured to store at least one license being used by the plurality of information processing apparatuses;
a history storage unit configured to store a usage history of the application software of each of the plurality of information processing apparatuses;
a license management unit configured to determine whether a license can be issued when a license issuance request is newly received from an information processing apparatus from among the plurality of information processing apparatuses;
a license issue unit configured to issue a license to the information processing apparatus according to a determination result of the license management unit; and
an excess license determination unit configured to determine whether to issue an excess license according to a usage history of an application software of each information processing apparatus stored in the history storage unit,
wherein the license management unit refers to the at least one license being used stored in the at least one license storage unit when a license issuance request is received from the information processing apparatus;
wherein the license management unit instructs the license issue unit to issue a license in a case where the license management unit determines there are remaining licenses; and
wherein the license management unit instructs the license issue unit to issue an excess license according to a determination result of the excess license issue unit in a case where the license management unit determines there is no remaining license.

3. A management server apparatus according to claim 2, wherein a usage history of the application software stored in the history storage unit is stored in each of the plurality of information processing apparatuses, and
the license management unit obtains each of the usage history from the plurality of information processing apparatuses.

4. The management server apparatus according to claim 2, wherein usage histories of the application software are obtained from the plurality of information processing apparatuses and are stored together in the history storage unit of the management server apparatus.

5. The management server apparatus according to claim 2, wherein a usage history stored in the history storage unit is at least one of cumulative usage time of an application software, usage frequency of an application software, and a number of license requests for using an application software in an information processing apparatus.

6. An information processing apparatus configured to request a management server apparatus to issue a license when using an application software and receive a license that enables use of the application software, the information processing apparatus comprising:
a history storage unit configured to store a usage history of the application software;
a license request unit configured to request the management server apparatus to newly issue a license when the application software is used; and
an application management unit configured to enable use of the application software based on a license received from the management server apparatus,
wherein the application management unit sends a usage history stored in the history unit to the management server apparatus.

7. An information processing apparatus according to claim 6, wherein a usage history stored in the history storage unit is at least one of cumulative usage time of an application software, usage frequency of an application software, and a number of license requests for using an application software in an information processing apparatus.

8. A method for controlling a license management system including a management server configured to manage and issue a specified number of licenses that enable use of an application software in a plurality of information processing apparatuses on which the application software is loaded and which requests the management server apparatus to issue a license when using an application software and receives a license that enables use of the application software, the method comprising:
storing at least one license being used in the plurality of information processing apparatuses;
storing a usage history of the application software of each of the plurality of information processing apparatus;
determining whether there are remaining licenses by referring to the stored at least one license being used when a license issuance request is newly received from an information processing apparatus from among the plurality of information processing apparatuses;
issuing a license to the information processing apparatus in a case where it is determined that there are remaining licenses; and
determining whether to issue an excess license to the information processing apparatus according to the stored usage history of an application software of each information processing apparatus in a case where it is determined that there are no remaining licenses, and issuing an excess license to the information processing apparatus according to the result of determining whether to issue an excess license.

9. A computer-readable storage medium storing computer-executable process steps, the computer-executable process steps causing a computer to execute the method of claim 8.

10. A method for controlling a management server apparatus configured to manage and issue a specified number of licenses to enable use of an application software in a plurality of information processing apparatuses, the method comprising:
storing at least one license being used by the plurality of information processing apparatuses;
storing a usage history of the application software of each of the plurality of information processing apparatuses;
determining whether there are remaining licenses by referring to the stored at least one license being used when a license issuance request is newly received from an information processing apparatus from among the plurality of information processing apparatuses;
issuing a license to the information processing apparatus in a case where it is determined that there are remaining licenses; and
determining whether to issue an excess license to the information processing apparatus according to the stored usage history of an application software of each information processing apparatus in a case where it is determined that there are no remaining licenses, and issuing an excess license to the information processing apparatus according to the result of determining whether to issue an excess license.

11. A method for controlling a management server apparatus according to claim 10, wherein a usage history of the application software is stored in each of the plurality of information processing apparatuses, and
wherein the method further comprises obtaining each of the usage history from the plurality of information processing apparatuses.

12. The method for controlling a management server apparatus according to claim 10, further comprising obtaining usage histories of the application software from the plurality of information processing apparatuses and storing the obtained usage histories together in the management server apparatus.

13. The method for controlling a management server apparatus according to claim 10, wherein a usage history stored in the history storage unit is at least one of cumulative usage time of an application software, usage frequency of an application software, and a number of license requests for using an application software in an information processing apparatus.

14. A computer-readable storage medium storing computer-executable process steps, the computer-executable process steps causing a computer to execute the method of claim 10.

15. A method for controlling an information processing apparatus configured to request a management server apparatus to issue a license when using an application software and which receives a license that enables use of the application software, the method comprising:
storing a usage history of the application software;
requesting a management server apparatus to newly issue a license when the application software is used;
enabling use of the application software based on a license received from the management server apparatus; and
sending a usage history stored in the history unit to the management server apparatus.

16. A method for controlling an information processing apparatus according to claim 15, wherein the usage history stored in the history storage unit is at least one of cumulative usage time of an application software, usage frequency of an application software, and a number of license requests for using an application software in an information processing apparatus.

17. A computer-readable storage medium storing computer-executable process steps, the computer-executable process steps causing a computer to execute the method of claim 15.
